(19) United States
(12) Patent Application Publication
(10) Pub. No.: US 2022/0297441 A1
(43) Pub. Date: Sep. 22, 2022

(54) PRINTING DEVICE AND BACK PRESSURE CONTROL METHOD

(71) Applicant: FUJIFILM Corporation, Tokyo (JP)

(72) Inventor: Yuichi OZAKI, Kanagawa (JP)

(73) Assignee: FUJIFILM Corporation, Tokyo (JP)

(21) Appl. No.: 17/835,174

(22) Filed: Jun. 8, 2022

Related U.S. Application Data
(63) Continuation of application No. PCT/JP2020/044932, filed on Dec. 2, 2020.

(30) Foreign Application Priority Data
Dec. 11, 2019 (JP) 2019-223915

(51) Int. Cl. B41J 2/18; B41J 2/165

(52) U.S. Cl. CPC B41J 2/18; B41J 2/16535

(57) ABSTRACT

A printing device includes an ink jet head that jets an ink from a jetting surface, an ink circulation flow passage through which the ink circulates, a moisturizing unit that moisturizes the jetting surface in an ink circulation stop period in which circulation of the ink in the ink circulation flow passage is stopped, a reception unit that receives a set input value of the ink circulation stop period, and a controller that controls a back pressure of the ink jet head at a start of the ink circulation stop period in accordance with the set input value of the ink circulation stop period received by the reception unit.

### CROSS-REFERENCE TO RELATED APPLICATION

This application is a continuation application of International Application No. PCT/JP2020/044932, filed Dec. 2, 2020, the disclosure of which is incorporated herein by reference in its entirety. Further, this application claims priority from Japanese Patent Application No. 2019-223915 filed on Dec. 11, 2019, the disclosures of which is incorporated herein by reference in its entirety.

### BACKGROUND OF THE INVENTION

### 1. Technical Field

The disclosed technology relates to a printing device and a back pressure control method.

### 2. Description of the Related Art

The following technology is known as technology of controlling prevention of drying of an ink adhering to a nozzle of an ink jet head and condensation of a jetting surface in an ink jet printing device. For example, JP2018-149764A discloses a liquid droplet jetting device comprising a jet head that jets liquid droplets of a jetting liquid from a nozzle disposed on a jetting surface, a jetting liquid tank that stores the jetting liquid, a circulation unit that circulates the jetting liquid between the jetting liquid tank and the jet head, a temperature adjustment unit that adjusts a temperature of the jetting liquid, a controller that sets the temperature of the jetting liquid adjusted by the temperature adjustment unit to a first temperature, a moisturizing cap that stores a cap liquid and covers the jetting surface to form a moisturizing space between the moisturizing cap and the jetting surface, a storage unit that stores a first relationship between the temperature of the jetting liquid and a temperature of the cap liquid for allowing humidity of the moisturizing space to be humidity at which drying of the nozzle and the condensation of the jetting surface are prevented, a temperature measurement unit that measures the temperature of the cap liquid, and a determination unit that determines whether or not the measured temperature of the cap liquid and the first temperature of the jetting liquid satisfy the first relationship, in which, in a case in which the determination unit determines that the first relationship is not satisfied, the controller sets the temperature of the jetting liquid to a second temperature at which the first relationship is satisfied in the measured temperature of the cap liquid.

On the other hand, JP2016-199021A discloses a printing device comprising an ink jet head that jets an ink, a wiping member that wipes the ink jet head, an ink storage unit that stores the ink supplied to the ink jet head, an ink circulation flow passage that includes a circulation sending flow passage through which the ink supplied from the ink storage unit to the ink jet head flows, and a circulation return flow passage through which the ink returning from the ink jet head to the ink storage unit flows, a circulation unit that circulates the ink in the ink circulation flow passage, and a first pressurization unit that pressurizes an inside of the ink storage unit to a first pressure higher than a pressure in the ink storage unit during a printing operation of jetting the ink to a printing medium by the ink jet head in a case of wiping in which the wiping member wipes the ink jet head, in which an operation of the circulation unit is stopped in a case of the wiping.

### SUMMARY

In a case in which an ink jet printing device is stopped, the ink circulation in an ink jet head is stopped. In a case in which the ink circulation is stopped, an ink adhering to the vicinity of an ink outlet (hereinafter referred to as outlet) of the ink jet head tends to dry, in a period in which the ink circulation is stopped (hereinafter, referred to as ink circulation stop period), an ink jetting surface (hereinafter, referred to as jetting surface) of the ink jet head is covered with a cap to suppress drying of the ink adhering to the vicinity of the outlet.

However, by moisturizing the jetting surface of the ink jet head with the cap for a long time, ink dripping from the outlet occurs. Ink dripping occurs due to the ink in the vicinity of the outlet absorbing moisture in the air and the meniscus of the ink formed in the vicinity of the outlet swelling to the outside of the ink jet head, or the ink in the vicinity of the outlet binding to water droplets adhering to the jetting surface of the ink jet head due to the condensation. Even in a case in which ink dripping on the jetting surface of the ink jet head is wiped by WetWeb built in the printing device in a case in which the printing device is operated, the ink cannot be completely absorbed, so that there is a problem, such as a jetting failure due to the ink left on the jetting surface or head modules adhering due to the ink being pushed into a gap between the head modules.

On the other hand, it is possible to suppress ink dripping by setting a back pressure of the ink jet head to a negative pressure during the ink circulation stop period. However, it is difficult to maintain a fixed back pressure of the ink jet head during the ink circulation stop period. That is, in a state in which the ink circulation is stopped, the back pressure of the ink jet head shifts to a positive pressure side with time. Therefore, as the ink circulation stop period is longer, a risk of the occurrence of ink dripping is higher. Therefore, in anticipation of the shift of the back pressure of the ink jet head to the positive pressure side with time and the condensation on the jetting surface of the ink jet head, it is also conceivable to set a set value of the back pressure at the start of the ink circulation stop period to the negative pressure having a sufficiently large absolute value. However, in a case in which a negative pressure level of the back pressure is excessively increased, the meniscus of the ink formed in the vicinity of the outlet of the ink jet head becomes a shape that is largely recessed inward the ink jet head, so that the ink in the vicinity of the outlet tends to dry. In addition, another problem arises in which the air bubbles easily enter from the outlet.

The disclosed technology is made in view of such circumstances, and is to provide a printing device and a back pressure control method in which ink dripping can be suppressed while suppressing drying of an ink and entering of air bubbles in an ink jet head during an ink circulation stop period.

An aspect of the disclosed technology relates to a printing device comprising an ink jet head that jets an ink from a jetting surface, an ink circulation flow passage through which the ink circulates, a moisturizing unit that moisturizes the jetting surface in an ink circulation stop period in which circulation of the ink in the ink circulation flow passage is stopped, a reception unit that receives a set input value of the ink circulation stop period, and a controller that controls a back pressure of the ink jet head at a start of the ink circulation stop period in accordance with the set input value of the ink circulation stop period received by the reception unit.

The controller may control a negative pressure level of the back pressure of the ink jet head at the start of the ink circulation stop period to be higher as the ink circulation stop period is longer. In addition, the controller may control the back pressure of the ink jet head at the start of the ink circulation stop period by using a table in which the ink circulation stop period and a set value of the back pressure of the ink jet head are associated with each other.

In addition, the controller may control the back pressure of the ink jet head at the start of the ink circulation stop period by using an expression representing a relationship between the ink circulation stop period and a set value of the back pressure of the ink jet head. In this case, in a case in which the ink circulation stop period is defined as X [h] and the set value of the back pressure of the ink jet head at the start of the ink circulation stop period is defined as Y [Pa], the expression may be Y=−30×X−1500±500.

The controller may control a negative pressure level of the back pressure of the ink jet head not to exceed a preset limit value.

The jetting surface of the ink jet head may be inclined with respect to a horizontal direction. The ink jet head may include a plurality of head modules, and the plurality of head modules may be arranged such that adjacent head modules have a gap therebetween. The printing device according to the disclosed technology may further comprise a wiping section that wipes the jetting surface by a wiping member.

The disclosed technology relates to a back pressure control method of an ink jet head of a printing device including the ink jet head that jets an ink from a jetting surface, an ink circulation flow passage through which the ink circulates, and a moisturizing unit that moisturizes the jetting surface in an ink circulation stop period in which circulation of the ink in the ink circulation flow passage is stopped, the method comprising receiving a set input value of the ink circulation stop period, an controlling a back pressure of the ink jet head at a start of the ink circulation stop period in accordance with the received set input value of the ink circulation stop period.

The disclosed technology provides the printing device and the back pressure control method in which ink dripping can be suppressed while suppressing drying of the ink and entering of air bubbles in the ink jet head during the ink circulation stop period.

### BRIEF DESCRIPTION OF THE DRAWINGS

Exemplary embodiments according to the technique of the present disclosure will be described in detail based on the following figures, wherein:

FIG. 1 is a side view showing a schematic configuration of an image recording unit of a printing device according to an embodiment of the disclosed technology;

FIG. 2 is a front view showing the schematic configuration of the image recording unit of the printing device according to the embodiment of the disclosed technology;

FIG. 3 is a perspective view of an ink jet head according to the embodiment of the disclosed technology;

FIG. 4 is an enlarged view of the ink jet head according to the embodiment of the disclosed technology as viewed from a jetting surface side;

FIG. 5 is a plan view showing an example of a jetting surface of a head module according to the embodiment of the disclosed technology;

FIG. 6 is a cross-sectional view showing an example of an internal structure of an ink chamber unit according to the embodiment of the disclosed technology;

FIG. 7 is a side view of a cleaning liquid applying section according to the embodiment of the disclosed technology;

FIG. 8 is a front view of a cleaning liquid applying unit according to the embodiment of the disclosed technology;

FIG. 9 is a side view of the cleaning liquid applying unit according to the embodiment of the disclosed technology;

FIG. 10 is a side view of a jetting surface wiping device according to the embodiment of the disclosed technology as viewed from a maintenance position side;

FIG. 11 is a plan view of a wiping unit according to the embodiment of the disclosed technology;

FIG. 12 is a front partial cross-sectional view of the wiping unit according to the embodiment of the disclosed technology;

FIG. 13 is a schematic configuration diagram of an ink circulation system according to the embodiment of the disclosed technology;

FIG. 14 is a graph showing an example of a time transition of a back pressure of the ink jet head according to a comparative example;

FIG. 15 is a diagram showing a result of a timing at which ink dripping occurs in a case in which a set value of the back pressure of the ink jet head at a start of an ink circulation stop period, which is acquired by an experiment;

FIG. 16 is a diagram showing a hardware configuration of a controller according to a first embodiment of the disclosed technology;

FIG. 17 is a diagram showing an example of a back pressure setting table in a storage unit according to the first embodiment of the disclosed technology;

FIG. 18 is a flowchart showing an example of a flow of a back pressure control process according to the first embodiment of the disclosed technology;

FIG. 19 is a graph showing an example of the time transition of the back pressure of the ink jet head according to the embodiment of the disclosed technology;

FIG. 20 is a diagram showing the hardware configuration of the controller according to a second embodiment of the disclosed technology;

FIG. 21 is a graph showing an example of a relationship between the ink circulation stop period and the set value of the back pressure at the start of the ink circulation stop period in which no ink dripping occurs; and

FIG. 22 is a flowchart showing an example of the flow of the back pressure control process according to the second embodiment of the disclosed technology.

### DETAILED DESCRIPTION

In the following, an example of embodiments of the invention will be described with reference to the drawings. It should be noted that the same or equivalent components and portions in the respective drawings are represented by the same reference numerals, and the overlapping description will be omitted.

### First Embodiment

<Configuration of Image Recording Unit of Printing Device>

As a printing device according to an embodiment of the disclosed technology, an example applied to a printing device that jets liquid droplets of an ink to record an image on a recording medium. The term recording medium used in recording the image is a general term of various terms, such as paper, recording paper, printing paper, a printing medium, a printed medium, an image formation medium, an image-formed medium, an image reception medium, and a jetted medium. A material, a shape, and the like of the recording medium are not particularly limited, and various sheet bodies can be used, such as seal paper, a resin sheet, a film, cloth, and a non-woven fabric, regardless of the material or the shape thereof. The recording medium is not limited to a single-sheet medium, the recording medium may be a continuous medium, such as continuous paper, continuous-form paper, and a film for flexible packaging. The continuous medium may be stored in a roll shape.

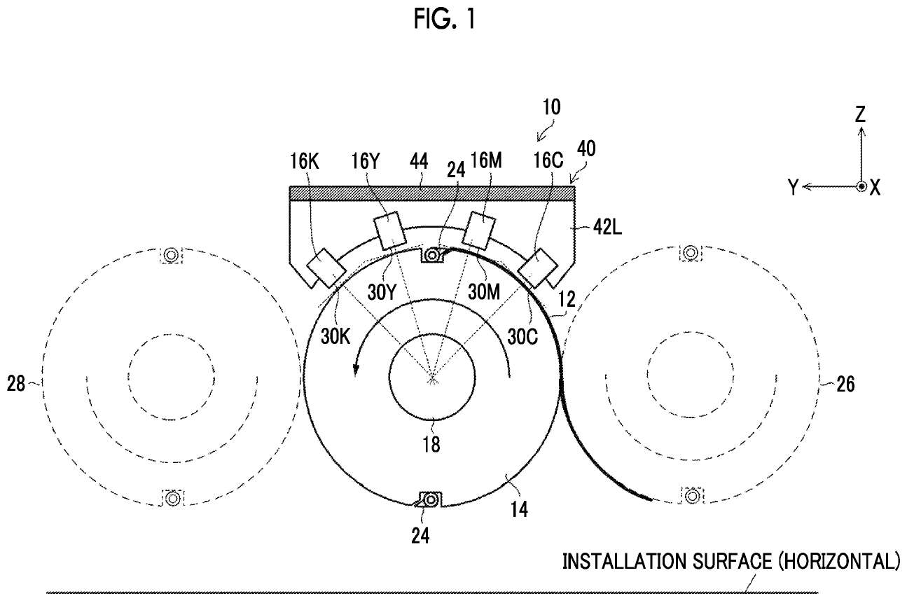

FIG. 1 is a side view of a schematic configuration of an image recording unit of the printing device that records the image on single-sheet paper through a single-pass method according to the embodiment of the disclosed technology. As shown in FIG. 1, an image recording unit 10 transports single-sheet paper 12 by an image recording drum 14. In addition, the image recording unit 10 jets ink droplets of cyan (C), magenta (M), yellow (Y), and black (K) during a transport process by the image recording drum 14 from ink jet heads 16C, 16M, 16Y, and 16K arranged around the image recording drum 14, respectively, to record a color image on a surface of the single-sheet paper 12.

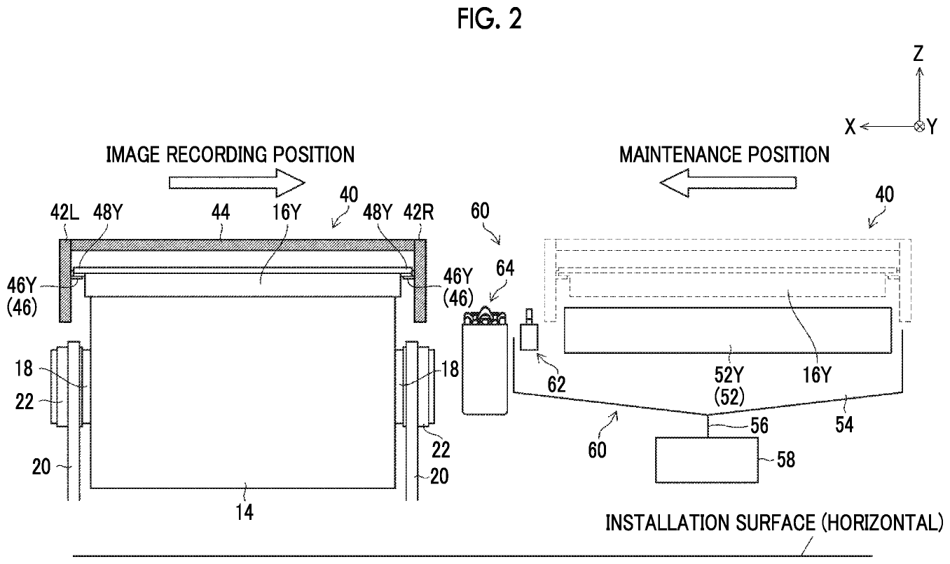

The image recording drum 14 has a rotation shaft 18, and both end portions of the rotation shaft 18 are rotatably provided by being pivotally supported by a pair of bearings 22 (see FIG. 2). The pair of bearings 22 is provided in a body frame 20 of the printing device, both end portions of the rotation shaft 18 are pivotally supported by the pair of bearings 22 to be parallel to a horizontal installation surface, and the image recording drum 14 is horizontally attached.

A motor (not shown) is connected to the rotation shaft 18 via a rotation transmission mechanism (not shown). The image recording drum 14 is driven by the motor (not shown) to be rotated.

The image recording drum 14 has a gripper 24 that grips a leading end portion of the single-sheet paper 12. The gripper 24 is provided in two places on an outer circumferential surface of the image recording drum 14, respectively. The leading end portion of the single-sheet paper 12 is gripped by the gripper 24, and is transported along the outer circumferential surface of the image recording drum 14.

The image recording drum 14 includes a suction holding mechanism (not shown), such as using electrostatic suction and vacuum suction. A rear surface of the single-sheet paper 12 of which a leading end portion is gripped by the gripper 24 and wound on the outer circumferential surface of the image recording drum 14 is sucked by the suction holding mechanism (not shown) and held on the outer circumferential surface of the image recording drum 14.

It should be noted that the single-sheet paper 12 before image recording is transported from a transporting drum 26 to the image recording drum 14. The transporting drum 26 is disposed to be juxtaposed with the image recording drum 14, and transports the single-sheet paper 12 to the image recording drum 14 in accordance with a timing.

In addition, the single-sheet paper 12 after image recording is transported from the image recording drum 14 to a transporting drum 28. The transporting drum 28 is disposed to be juxtaposed with the image recording drum 14, and receives the single-sheet paper 12 from the image recording drum 14 in accordance with a timing.

The four ink jet heads 16C, 16M, 16Y, and 16K are line heads corresponding to a length of the single-sheet paper 12 in an X direction. The X direction is a direction along an axial direction of the rotation shaft 18.

The ink jet heads 16C, 16M, 16Y, and 16K are attached to a head support frame 40, and are disposed radially at fixed intervals on a concentric circle about the rotation shaft 18 of the image recording drum 14 and to be bilaterally symmetrical to each other with the image recording drum 14 interposed therebetween. That is, with respect to a vertical line segment passing through the center of the image recording drum 14, the ink jet head 16C of cyan and the ink jet head 16K of black are disposed to be bilaterally symmetrical to each other and the ink jet head 16M of magenta and the ink jet head 16Y of yellow are disposed to be bilaterally symmetrical to each other.

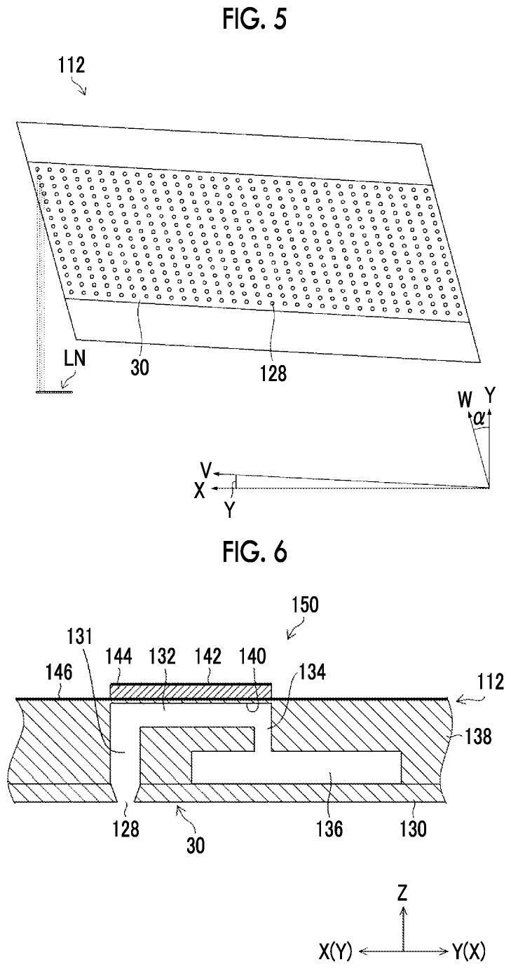

The ink jet heads 16C, 16M, 16Y, and 16K have jetting surfaces 30C, 30M, 30Y, and 30K, each of which has an outlet 128 (see FIG. 5) disposed in a bottom portion. The ink jet heads 16C, 16M, 16Y, and 16K are disposed to be orthogonal to a Y direction, which is a transport direction of the single-sheet paper 12, and are disposed such that the jetting surfaces 30C, 30M, 30Y, and 30K face the outer circumferential surface of the image recording drum 14. The ink jet heads 16C, 16M, 16Y, and 16K are disposed such that an interval between the outer circumferential surface of the image recording drum 14 and each of the jetting surfaces 30C, 30M, 30Y, and 30K is the same distance. The jetting surfaces 30C, 30M, 30Y, and 30K are disposed to face the outer circumferential surface of the image recording drum 14, and are inclined with respect to a horizontal direction.

The ink jet heads 16C, 16M, 16Y, and 16K jet the ink droplets vertically toward the outer circumferential surface of the image recording drum 14 from the outlets 128 disposed in the jetting surfaces 30C, 30M, 30Y, and 30K.

FIG. 2 is a front view showing a schematic configuration of the image recording unit of the printing device. The head support frame 40 to which the ink jet heads 16C, 16M, 16Y, and 16K are attached is composed of a pair of side plates 42L and 42R provided to be orthogonal to the rotation shaft 18 of the image recording drum 14 and a connection frame 44 that connects upper end portions of the pair of side plates 42L and 42R to each other.

The pair of side plates 42L and 42R has a plate shape and is disposed to face each other with the image recording drum 14 interposed therebetween. On an inside of the pair of side plates 42L and 42R, attachment portions for attaching the ink jet heads 16C, 16M, 16Y, and 16K are provided. It should be noted that, for convenience, FIG. 2 shows only the attachment portion 46Y. In the following, in a case in which the distinction is not necessary or the general term is used, the attachment portions corresponding to the ink jet heads 16C, 16M, 16Y, and 16K are referred to as the attachment portion 46.

The attachment portions 46 are disposed radially at fixed intervals on the concentric circle about the rotation shaft 18 of the image recording drum 14. The ink jet heads 16C, 16M, 16Y, and 16K are attached to the head support frame 40 by fixing attached portions provided in both ends to the attachment portion 46, respectively. It should be noted that, for convenience, FIG. 2 shows only the attached portion 48Y.

The head support frame 40 is guided by a guide rail (not shown), and is provided to be slidably movable along the axial direction of the rotation shaft 18 of the image recording drum 14. The head support frame 40 is driven by a linear drive mechanism (not shown) (for example, feed screw mechanism and the like) to move at a predetermined movement speed between an “image recording position” shown by a solid line in FIG. 2 and a “maintenance position” shown by a broken line in FIG. 2.

In a case in which the head support frame 40 is positioned at the image recording position, the ink jet heads 16C, 16M, 16Y, and 16K are disposed around the image recording drum 14, and are in a state in which the image can be recorded.

The maintenance position is set to a position at which the ink jet heads 16C, 16M, 16Y, and 16K are retracted from the image recording drum 14. A moisturizing unit 50 that moisturizes the ink jet heads 16C, 16M, 16Y, and 16K is provided at the maintenance position.

The moisturizing unit 50 comprises caps that cover the jetting surfaces 30C, 30M, 30Y, and 30K of 16K of the ink jet heads 16C, 16M, 16Y, and 16K, respectively. It should be noted that, for convenience, FIG. 2 shows only the cap 52Y. In the following, in a case in which the distinction is not necessary or the general term is used, the caps corresponding to the ink jet heads 16C, 16M, 16Y, and 16K are referred to as the cap 52. A moisturizing liquid is stored in the cap 52. In a case in which the printing device is stopped, the jetting surfaces 30C, 30M, 30Y, and 30K are covered with the cap 52 in which the moisturizing liquid is stored. As a result, it is possible to prevent non-jetting caused by drying of the outlets 128.

It should be noted that the cap 52 comprises a pressurization mechanism and a suction mechanism (not shown), and can pressurize and suck the nozzles communicating the outlets 128. In addition, the cap 52 comprises a cleaning liquid supply mechanism (not shown), and can supply a cleaning liquid to the inside.

A waste liquid tray 54 is disposed at a position below the cap 52. The cleaning liquid supplied to the cap 52 is wasted to the waste liquid tray 54, and is collected in a waste liquid tank 58 via a waste liquid collection pipe 56.

A jetting surface cleaning device 60 that cleans the jetting surfaces 30C, 30M, 30Y, and 30K of the ink jet heads 16C, 16M, 16Y, and 16K is provided between the image recording position and the maintenance position. By moving the ink jet heads 16C, 16M, 16Y, and 16K between the maintenance position and the image recording position, the jetting surfaces 30C, 30M, 30Y, and 30K are cleaned by the jetting surface cleaning device 60.

<Configuration Example of Ink Jet Head>

The ink jet heads 16C, 16M, 16Y, and 16K have the common configuration. In the following, in a case in which the distinction is not necessary or the general term is used, the ink jet heads 16C, 16M, 16Y, and 16K are referred to as the ink jet head 16.

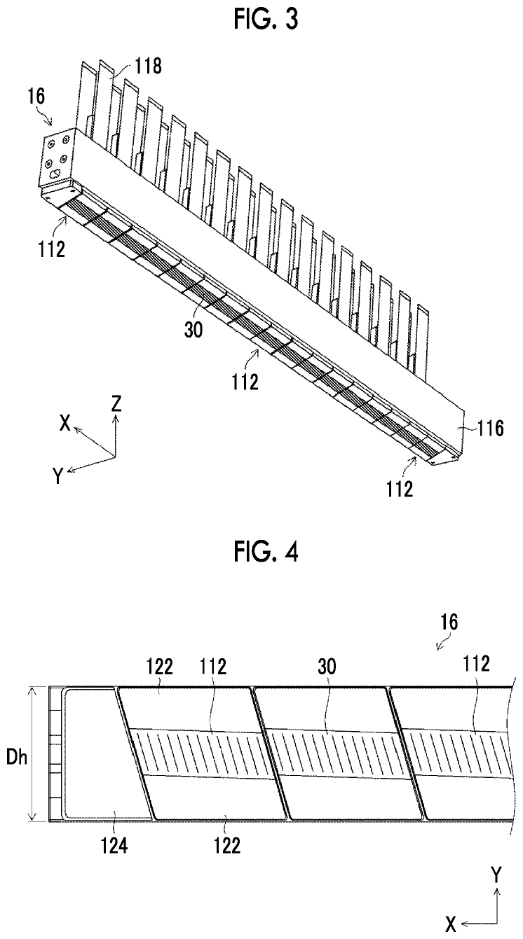

FIG. 3 is a perspective view of the ink jet head 16. The ink jet head 16 is configured by connecting n head modules 112 (i=1, 2, . . . n) to each other in the X direction. Here, an example is shown in which 17 (n=17) head modules 112 are arranged. A frame 116 functions as a frame for fixing the n head modules 112. The head modules 112 are arranged such that adjacent head modules have a gap therebetween, and each of which is fixed to the frame 116 with the jetting surface 30 facing in a common direction. A structure of each of the head modules 112 is common.

A flexible substrate 118 is connected to each of the head modules 112. A drive signal, a jetting control signal, and the like are supplied to each of the head modules 112 via the flexible substrates 118.

FIG. 4 is an enlarged view of the ink jet head 16 as viewed from the jetting surface 30 side. As shown in FIG. 4, a length of the ink jet head 16 in a direction orthogonal to the X direction, which is a Y direction along the jetting surface 30, is Dh. The ink jet head 16 supports each of the head modules 112 from both sides in the Y direction by a head module holding member 122. In addition, the ink jet head 16 supports a head module row consisting of the n head modules 112 from both sides in the X direction by a head protective member 124.

FIG. 5 is a plan view showing an example of the jetting surface 30 of the head module 112. The head module 112 has a parallel quadrilateral shape in a plan view, which has end surfaces on a long side along a V direction having an inclination of an angle γ with respect to the X direction and end surfaces on a short side along a W direction having an inclination of an angle α with respect to the Y direction. The outlets 128 are two-dimensionally arranged on the jetting surface 30. The outlet 128 has a circular shape in an XY-plan view in the example shown in FIG. 5, but may have a quadrangular shape or a polygonal shape.

An arrangement LN of the outlets 128 projected in the X direction is equivalent to an array in which the outlets 128 are arranged at equal intervals in the X direction at a density that achieves a desired recording resolution. A nozzle density of the head module 112 in the X direction is, for example, 1200 dots per inch (dpi).

By connecting the n head modules 112 in the X direction (see FIG. 3), in the ink jet head 16, the outlets 128 are disposed over the entire length of the single-sheet paper 12 in the X direction. That is, the ink jet head 16 is a full-line type bar head capable of printing at a recording resolution of 1200 dpi in one time of transporting of the single-sheet paper 12.

The full-line type bar head applied to the single-pass method is not limited to a case in which the entire surface of the single-sheet paper 12 is set as a printing range, and the outlets need only be disposed in a range necessary for printing in a case in which a part of the single-sheet paper 12 is set as a printing region, such as a case in which a margin portion is provided around the single-sheet paper 12.

The number of outlets 128 provided in the head module 112, the density of the outlets 128, and the arrangement form of the outlets 128 are not particularly limited. The present embodiment is particularly effective for the ink jet head having a resolution of 600 dpi or more.

<Example of Internal Structure of Head Module>

The head module 112 comprises a plurality of ink chamber units 150 (see FIG. 6) comprising a jetting energy generation element (for example, piezoelectric element or heat generation element), which generates jetting energy necessary for ink jetting, corresponding to each of the outlets 128. The head module 112 jets the ink on demand in accordance with the drive signal and the jetting control signal which are supplied via the flexible substrate 118.

FIG. 6 is a cross-sectional view showing an example of an internal structure of the ink chamber unit 150 provided in the head module 112. The ink chamber unit 150 includes a nozzle plate 130 in which the outlet 128 is formed, and a flow passage plate 138 in which flow passages, such as a nozzle 131 communicating with the outlet 128, a pressure chamber 132, a supply port 134, and a common flow passage 136 are formed.

The flow passage plate 138 is a flow passage forming member that configures a side wall portion of the outlet 128 and the pressure chamber 132 and forms the supply port 134 which is a narrowed portion (most constricted portion) of an individual supply passage through which the ink is introduced from the common flow passage 136 to the pressure chamber 132. The flow passage plate 138 may be composed of one substrate, or may have a structure obtained by laminating a plurality of substrates. The nozzle plate 130 and the flow passage plate 138 can be processed into a required shape using a semiconductor manufacturing technology with silicon as a material.

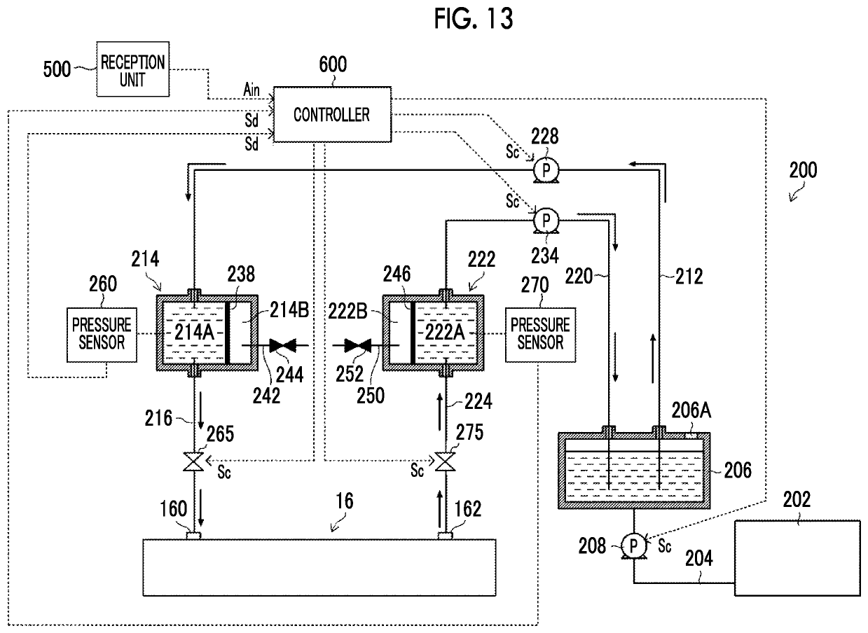

The pressure chamber 132 of each of the plurality of ink chamber units 150 is connected to the common flow passage 136 via each of the supply ports 134. In addition, the common flow passage 136 communicates with an ink supply port 160 and an ink collection port 162 (see FIG. 13), which are provided in the ink jet head 16, and the ink circulates by an ink circulation system 200 (see FIG. 13).

A piezoelectric element 144 is provided for each pressure chamber 132 on a surface of a vibration plate 140 configuring a part of a surface (top surface in FIG. 6) of the pressure chamber 132. An individual electrode 142 for individually applying a voltage to a piezoelectric element 144 for each pressure chamber 132 is provided on the surface of a piezoelectric element 144. The vibration plate 140 is made of silicon with a conductive layer that functions as a common electrode 146 commonly used for the piezoelectric element 144 for each pressure chamber 132. It should be noted that, an aspect can be adopted in which the vibration plate 140 is made of a non-conductive material, such as a resin, and in this case, a common electrode layer made of a conductive material, such as a metal, is formed on the surface of the vibration plate 140. In addition, the vibration plate that serves as the common electrode may be made of a metal (conductive material), such as stainless steel.

As a drive voltage is applied to the individual electrode 142, the piezoelectric element 144 deforms and the volume of the pressure chamber 132 is changed, and the ink is jetted from the outlet 128 due to a pressure change associated with the volume change. After ink jetting, the pressure chamber 132 is again filled with a new ink from the common flow passage 136 through the supply port 134.

As the drive voltage to be applied to the individual electrode 142 is selected, the head module 112 can jet any ink droplet among three types of ink droplets, including a small droplet with a relatively small ink amount from each of the outlets 128, a medium droplet with an ink amount relatively larger than the small droplet, and a large droplet with an ink amount relatively larger than the medium droplet. As described above, the head module 112 can form a plurality of ink dots having different diameters on the single-sheet paper 12.

<Configuration of Jetting Surface Cleaning Device>

As shown in FIG. 2, the jetting surface cleaning device 60 is composed of a cleaning liquid applying section 62 that cleans the jetting surfaces 30C, 30M, 30Y, and 30K of the ink jet heads 16C, 16M, 16Y, and 16K by applying the cleaning liquid and a wiping section 64 that wipes the jetting surfaces 30C, 30M, 30Y, and 30K to which the cleaning liquid is applied. The jetting surface cleaning device 60 is disposed on a movement path of the head support frame 40.

The jetting surface cleaning device 60 cleans the jetting surfaces 30C, 30M, 30Y, and 30K by moving the ink jet heads 16C, 16M, 16Y, and 16K from the maintenance position to the image recording position, or from the image recording position to the maintenance position (example of relative movement).

The wiping section 64 is disposed on the image recording position side with respect to the cleaning liquid applying section 62 in the example shown in FIG. 2, but may be disposed on the maintenance position side with respect to the cleaning liquid applying section 62.

<Configuration of Cleaning Liquid Applying Section>

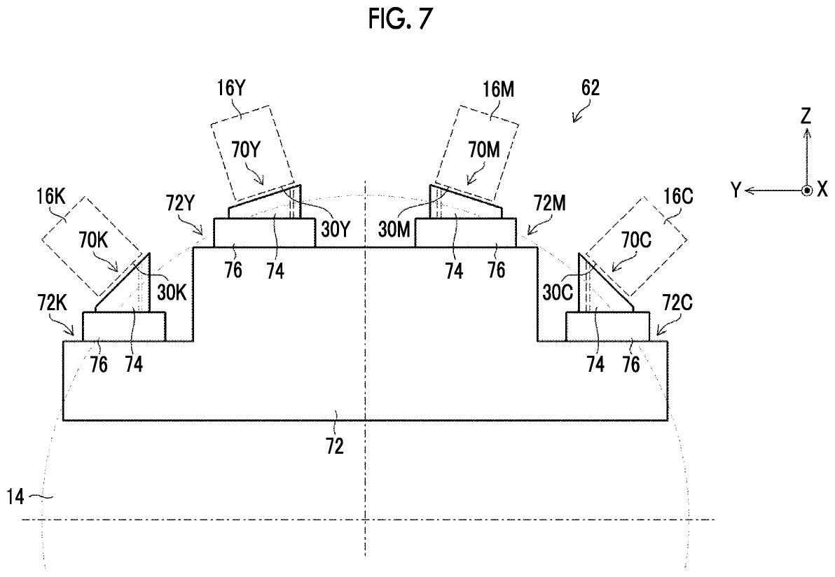

FIG. 7 is a side view of the cleaning liquid applying section 62 as viewed from the maintenance position side. The cleaning liquid applying section 62 is provided on an inside of the waste liquid tray 54 provided in the moisturizing unit 50 (see FIG. 2). The cleaning liquid applying section 62 comprises cleaning liquid applying units 70C, 70M, 70Y, and 70K which are provided to correspond to the ink jet heads 16C, 16M, 16Y, and 16K respectively, and a body 72 on which the cleaning liquid applying units 70C, 70M, 70Y, and 70K are mounted.

The body 72 is horizontally provided and is freely raised and lowered by a raising and lowering device (not shown). The body 72 includes cleaning liquid applying unit attachment portions 72C, 72M, 72Y, and 72K on an upper surface portion. The cleaning liquid applying units 70C, 70M, 70Y, and 70K are fixed to the cleaning liquid applying unit attachment portions 72C, 72M, 72Y, and 72K provided in the body 72 by a bolt and the like, and are disposed on the movement paths of the corresponding ink jet heads 16C, 16M, 16Y, and 16K.

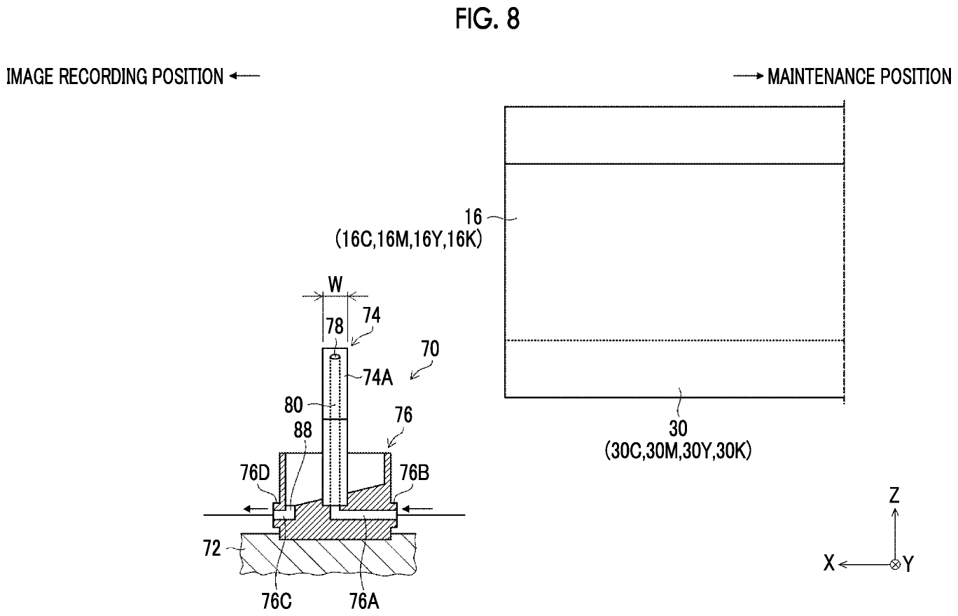

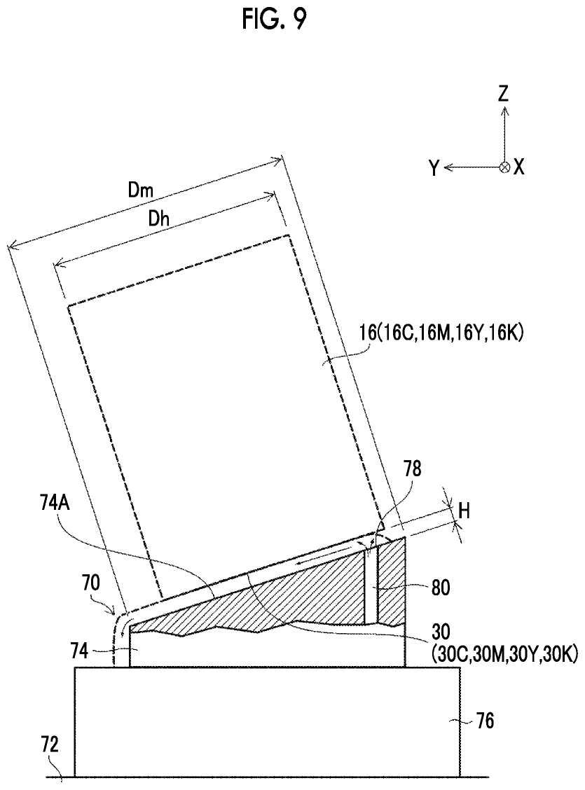

The basic configurations of the cleaning liquid applying units 70C, 70M, 70Y, and 70K are common. In the following, in a case in which the distinction is not necessary or the general term is used, the cleaning liquid applying units 70C, 70M, 70Y, and 70K are referred to as the cleaning liquid applying unit 70. FIGS. 8 and 9 are a front view and a side view of the cleaning liquid applying unit 70, respectively. As shown in FIGS. 8 and 9, the cleaning liquid applying unit 70 comprises a cleaning liquid applying head 74 that applies the cleaning liquid to the jetting surface 30 and a cleaning liquid collection dish 76 that collects the cleaning liquid that falls from the jetting surface 30.

The cleaning liquid collection dish 76 has a rectangular box shape with an open upper portion. The cleaning liquid applying head 74 is vertically erected inside the cleaning liquid collection dish 76.

The cleaning liquid applying head 74 has a square block shape, and comprises a cleaning liquid holding surface 74A inclined with respect to a horizontal surface on the upper portion. The cleaning liquid holding surface 74A has the same inclined angle as the jetting surface 30 of the ink jet head 16, which is a cleaning target. That is, the cleaning liquid holding surface 74A is parallel to the jetting surface 30 of the ink jet head 16, which is the cleaning target.

The cleaning liquid applying head 74 cleans the jetting surface 30 facing the cleaning liquid holding surface 74A with the cleaning liquid held by the cleaning liquid holding surface 74A. The cleaning liquid holding surface 74A has a rectangular shape of which a length in the X direction is W and a length in the direction orthogonal to the X direction, which is a direction along the cleaning liquid holding surface 74A, is Dm, which is larger than Dh. That is, a relationship of Dm>Dh is satisfied.

It should be noted that, in a case of cleaning the jetting surface 30, the entire jetting surface 30 faces the cleaning liquid holding surface 74A. In addition, an interval (distance) between the jetting surface 30 and the cleaning liquid holding surface 74A in a case in which the jetting surface 30 and the cleaning liquid holding surface 74A face each other is H.

Further, a cleaning liquid jetting port 78 from which the cleaning liquid is jetted is disposed at a position facing the head module holding member 122 in a case in which the jetting surface 30 and the cleaning liquid holding surface 74A face each other, which is in the vicinity of the upper portion of the cleaning liquid holding surface 74A in an inclination direction. The cleaning liquid jetted from the cleaning liquid jetting port 78 flows and falls from the inclined cleaning liquid holding surface 74A. As a result, a layer (film) of the cleaning liquid is formed on the cleaning liquid holding surface 74A. By bringing the jetting surface 30 of the ink jet head 16 into contact with the layer of the cleaning liquid formed on the cleaning liquid holding surface 74A, the cleaning liquid is applied to the jetting surface 30, and the jetting surface 30 is cleaned by the applied cleaning liquid.

The cleaning liquid applying head 74 includes a supply flow passage 80 that communicates with the cleaning liquid jetting port 78. The supply flow passage 80 communicates with a communication flow passage 76A provided in the cleaning liquid collection dish 76. The communication flow passage 76A communicates with a cleaning liquid supply port 76B provided in the cleaning liquid collection dish 76. As the cleaning liquid is supplied to the cleaning liquid supply port 76B, the cleaning liquid applying head 74 jets the cleaning liquid from the cleaning liquid jetting port 78.

The cleaning liquid is supplied from a cleaning liquid tank (not shown) to the cleaning liquid supply port 76B. A pipe (not shown) connected to the cleaning liquid tank is connected to the cleaning liquid supply port 76B. A cleaning liquid supply pump (not shown) and a valve (not shown) are provided in the pipe. In a case in which a valve is opened and the cleaning liquid supply pump is driven, the cleaning liquid is supplied from the cleaning liquid tank to the cleaning liquid applying head 74.

In addition, a bottom portion of the cleaning liquid collection dish 76 is inclined with respect to the horizontal surface, and has a collection hole 88 in a lower end portion in the inclination direction. The collection hole 88 communicates with a cleaning liquid outlet 76D via a collection flow passage 76C. The cleaning liquid outlet 76D is connected to the waste liquid tank 58 (see FIG. 2) via a pipe (not shown). The cleaning liquid jetted from the cleaning liquid jetting port 78 of the cleaning liquid applying head 74 flows and falls from the cleaning liquid holding surface 74A to be collected in the cleaning liquid collection dish 76, and is collected in the waste liquid tank 58 via the pipe (not shown).

Here, the cleaning liquid is supplied to the cleaning liquid holding surface 74A by jetting the cleaning liquid from the cleaning liquid jetting port 78 disposed in the cleaning liquid holding surface 74A, but a method of supplying the cleaning liquid is not limited to this. For example, the cleaning liquid may be supplied by adding the cleaning liquid dropwise in the vicinity of the upper portion of the cleaning liquid holding surface 74A in the inclination direction from the cleaning liquid nozzle which is separately provided.

For example, a cleaning liquid containing diethylene monobutyl ether as a main component is used as the cleaning liquid. By applying this type of the cleaning liquid to the jetting surface 30, it is possible to dissolve and easily remove an ink-derived adhered matter adhering to the jetting surface 30.

<Configuration of Wiping Section>

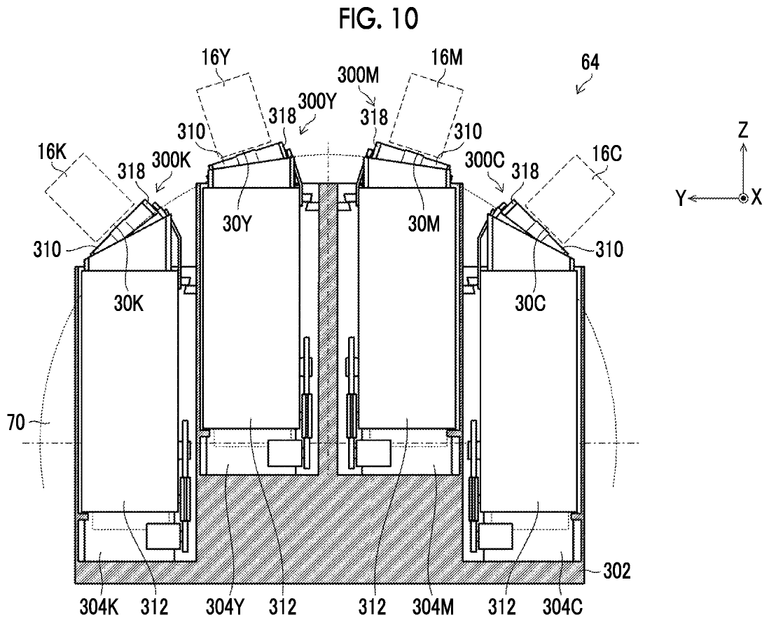

FIG. 10 is a side view of the wiping section 64 as viewed from the maintenance position side. As shown in FIG. 10, the wiping section 64 comprises wiping units 300C, 300M, 300Y, and 300K which are provided to correspond to the ink jet heads 16C, 16M, 16Y, and 16K, and a body frame 302 on which the wiping units 300C, 300M, 300Y, and 300K are set.

<Configuration of Body Frame>

The body frame 302 has a box shape in which an upper end portion is open. The body frame 302 is horizontally provided and is freely raised and lowered by the raising and lowering device (not shown). Wiping unit mounting portions 304C, 304M, 304Y, and 304K on which the wiping units 300C, 300M, 300Y, and 300K are mounted are provided inside the body frame 302.

The wiping unit mounting portions 304C, 304M, 304Y, and 304K are spaces which can accommodate the wiping units 300C, 300M, 300Y, and 300K, and the upper portions thereof are open. By being inserted vertically downward from upper opening portions of the wiping unit mounting portions 304C, 304M, 304Y, and 304K, the wiping units 300C, 300M, 300Y, and 300K are set on the wiping unit mounting portions 304C, 304M, 304Y, and 304K.

It should be noted that the wiping unit mounting portions 304C, 304M, 304Y, and 304K comprise a lock mechanism (not shown), and the mounted wiping units 300C, 300M, 300Y, and 300K are locked by the lock mechanism. In a case in which the wiping units 300C, 300M, 300Y, and 300K are inserted into the wiping unit mounting portions 304C, 304M, 304Y, and 304K, the lock mechanism is operated automatically.

<Configuration of Wiping Unit>

The basic configurations of the wiping units 300C, 300M, 300Y, and 300K are common. In the following, in a case in which the distinction is not necessary or the general term is used, the wiping units 300C, 300M, 300Y, and 300K are referred to as the wiping unit 300.

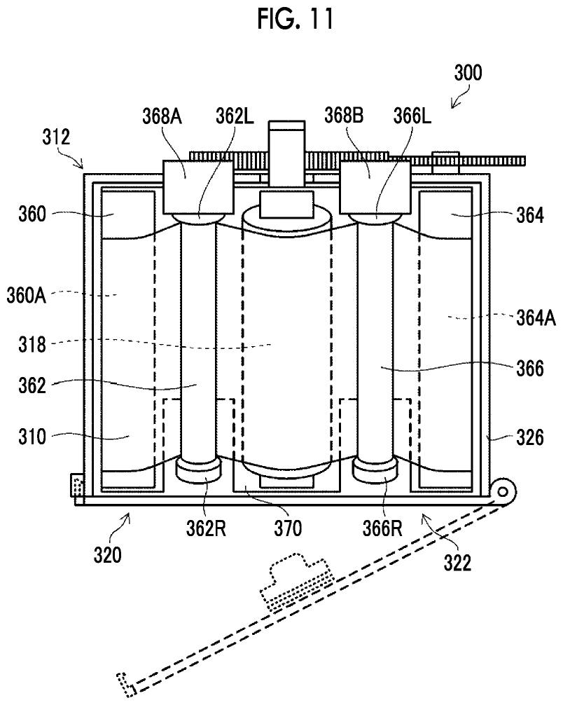

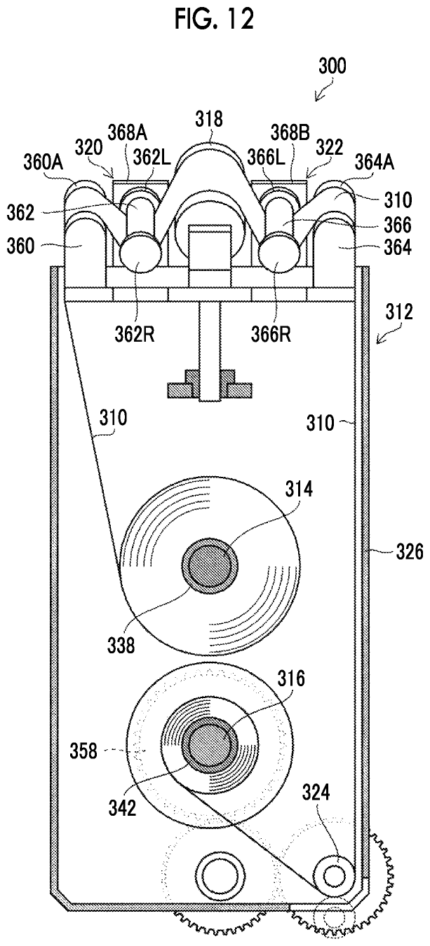

FIG. 11 is a plan view of the wiping unit 300, and FIG. 12 is a front partial cross-sectional view of the wiping unit 300. As shown in FIGS. 11 and 12, the wiping unit 300 wipes the jetting surface 30 by winding a strip-shaped wiping web 310 (example of a wiping member) around a pressing roller 318 installed in an inclined manner, and pressing and abutting the wiping web 310 wound around the pressing roller 318 with the jetting surface 30 (see FIG. 3) of the ink jet head 16. In the present embodiment, the wiping unit 300 wipes the jetting surface 30 by the wiping web 310 which is in a dry state in which the cleaning liquid is not allowed to be infiltrated.

The wiping unit 300 comprises a case 312, a feeding shaft 314 that feeds the wiping web 310, a rolling shaft 316 that rolls the wiping web 310, a front stage guide 320 that guides the wiping web 310 fed from the feeding shaft 314 to be wound around the pressing roller 318, a rear stage guide 322 that guides the wiping web 310 wound around the pressing roller 318 to be rolled by the rolling shaft 316, and a grid roller (drive roller) 324 that transports the wiping web 310.

The feeding shaft 314 has a cylindrical shape. The feeding shaft 314 is fixed (cantilever-supported) to a pivot-support unit of which a base end portion is provided in a case body 326, and is horizontally provided inside the case body 326. On the feeding shaft 314, a feeding core 338 is attachably and detachably mounted. It should be noted that a length of the feeding shaft 314 is slightly shorter than a length of the feeding core 338. Therefore, in a case in which the feeding core 338 is mounted, the feeding shaft 314 retracts to an inner circumferential portion of the feeding core 338.

The feeding core 338 has a cylindrical shape. The strip-shaped wiping web 310 is wound around the feeding core 338 in a roll shape.

The feeding core 338 is mounted on the feeding shaft 314 by inserting the feeding shaft 314 into the inner circumferential portion to be fitted to the feeding shaft 314. The feeding core 338 mounted on the feeding shaft 314 is rotated around the feeding shaft 314 and is rotatably supported.

It should be noted that the wiping web 310 is composed of, for example, a sheet consisting of knitting or weaving made of ultrafine fibers, such as polyethylene terephthalate (PET), polyethylene (PE), and nylon (NY). The wiping web 310 has a width corresponding to a width of the ink jet head 16, which is a wiping target.

The rolling shaft 316 is horizontally provided at a position below the feeding shaft 314. That is, the rolling shaft 316 and the feeding shaft 314 are disposed to be vertically juxtaposed.

A rolling core 342 which rolls the wiping web 310 fed from the feeding core 338 is mounted on the rolling shaft 316.

A configuration of the rolling core 342 is almost the same as a configuration of the feeding core 338. That is, the rolling core 342 has a cylindrical shape. A distal end of the wiping web 310 wound around the feeding core 338 is fixed to the rolling core 342.

The rolling core 342 is mounted on the rolling shaft 316 by fitting the rolling shaft 316 to an inner circumferential portion.

A base end portion of main shaft of the rolling shaft 316 is provided to protrude to an outside of the case body 326, and a rolling shaft gear 358 is attached to the protruding base end portion. The rolling shaft 316 (main shaft) is rotated as the rolling shaft gear 358 is rotationally driven by a motor (not shown).

The pressing roller 318 is disposed above the feeding shaft 314 (in the present example, the pressing roller 318, the feeding shaft 314, and the rolling shaft 316 are disposed on the same line), and is disposed to be inclined at a predetermined angle with respect to the horizontal surface. That is, since the pressing roller 318 causes the wiping web 310 to be pressed and abutted to the jetting surface 30 of the ink jet head 16, the pressing roller is disposed to be inclined in accordance with an inclination with respect to the horizontal surface of the jetting surface 30 of the ink jet head 16, which is the wiping target, and the pressing roller 318 and the jetting surface 30 are disposed to be parallel to each other.

The front stage guide 320 is composed of a first front stage guide 360 and a second front stage guide 362, and guides the wiping web 310 fed from the feeding shaft 314 to be wound around the pressing roller 318 installed in an inclined manner.

On the other hand, the rear stage guide 322 is composed of a first rear stage guide 364 and a second rear stage guide 366, and guides the wiping web 310 wound around the pressing roller 318 installed in an inclined manner to be rolled by the rolling shaft 316 which is horizontally installed.

The front stage guide 320 and the rear stage guide 322 are symmetrically disposed with the pressing roller 318 interposed therebetween. That is, the first front stage guide 360 and the first rear stage guide 364 are disposed symmetrically with the pressing roller 318 interposed therebetween, and the second front stage guide 362 and the second rear stage guide 366 are disposed symmetrically with the pressing roller 318 interposed therebetween.

The first front stage guide 360 has a plate shape having a predetermined width, and is vertically erected on a raising and lowering stage 370. The first front stage guide 360 has an upper edge portion 360A, which is a wound portion of the wiping web 310, and has an arc shape on the surface. In addition, the upper edge portion 360A is inclined at a predetermined angle with respect to the horizontal surface. As a result, a traveling direction of the wiping web 310 is converted.

The first rear stage guide 364 has the same configuration as the first front stage guide 360. That is, the first rear stage guide 364 has a plate shape having a predetermined width, and is vertically erected on the raising and lowering stage 370. The first rear stage guide 364 has an upper edge portion 364A, which is a wound portion of the wiping web 310, and has an arc shape. In addition, the upper edge portion 364A is inclined at a predetermined angle with respect to the horizontal surface.

The first front stage guide 360 and the first rear stage guide 364 are symmetrically disposed with the pressing roller 318 interposed therebetween. By being wound around the first front stage guide 360, a direction of the wiping web 310 fed from the feeding shaft 314 is changed from a direction orthogonal to the feeding shaft 314 to a direction substantially orthogonal to the pressing roller 318. In addition, by being wound around the first rear stage guide 364, the direction of the wiping web 310 wound around the second rear stage guide 366 is changed to a direction orthogonal to the rolling shaft 316.

The second front stage guide 362 is configured as a guide roller that includes flanges 362L and 362R in both end portions. The second front stage guide 362 is disposed between the first front stage guide 360 and the pressing roller 318, and guides the wiping web 310 wound around the first front stage guide 360 to be wound around the pressing roller 318. That is, the traveling direction of the wiping web 310 is finely adjusted such that the wiping web 310 of which a direction is changed to the direction substantially orthogonal to the pressing roller 318 by the first front stage guide 360 travels in the direction orthogonal to the pressing roller 318. In addition, skewing of the wiping web 310 is prevented by the flanges 362L and 362R in both ends.

The second front stage guide 362 is provided in an inclined manner at a predetermined angle as one end thereof is cantilever-supported by a bracket 368A. As shown in FIG. 11, the bracket 368A has a plate shape in which a distal end is bent, and a base end portion thereof is fixed to a rear surface upper end portion of the case body 326. The bracket 368A is provided to vertically protrude upward from the upper end portion of the case body 326. The second front stage guide 362 is supported to be movable rotationally by being cantilever-supported by a bent portion of the distal end of the bracket 368A.

The second rear stage guide 366 has the same configuration as the second front stage guide 362. That is, the second rear stage guide 366 is configured as a guide roller that includes flanges 366L and 366R in both end portions, and is provided in an inclined manner at a predetermined angle with one end thereof is cantilever-supported by a bracket 368B. The bracket 368B has a plate shape in which a distal end is bent, and a base end portion thereof is fixed to the rear surface upper end portion of the case body 326. The second rear stage guide 366 is supported to be movable rotationally by being cantilever-supported by a bent portion of the distal end of the bracket 368B.

The second rear stage guide 366 is disposed between the pressing roller 318 and the first rear stage guide 364, and guides the wiping web 310 wound around the pressing roller 318 to be wound around the first rear stage guide 364.

The second front stage guide 362 and the second rear stage guide 366 are symmetrically disposed with the pressing roller 318 interposed therebetween. The traveling direction is finely adjusted such that the wiping web 310 of which a direction is changed to the direction substantially orthogonal to the pressing roller 318 by the first front stage guide 360 is wound around the second front stage guide 362 to travel in the direction orthogonal to the pressing roller 318. In addition, the traveling direction is finely adjusted by the second rear stage guide 366 such that the wiping web 310 wound around the pressing roller 318 is wound around the first rear stage guide 364. By being wound around the first rear stage guide 364, the direction of the wiping web 310 is changed to the direction orthogonal to the rolling shaft 316.

As described above, by switching the traveling direction of the wiping web 310 step by step, the front stage guide 320 and the rear stage guide 322 guide the wiping web 310 to be wound around the pressing roller 318 without difficulty.

Therefore, the inclined angle of the second front stage guide 362 is an angle close to the inclined angle of the pressing roller 318 as compared with the inclined angle of the first front stage guide 360. Similarly, the inclined angle of the second rear stage guide 366 is an angle close to the inclined angle of the pressing roller 318 as compared with the inclined angle of the first rear stage guide 364.

<Ink Circulation System>

FIG. 13 is a schematic configuration diagram of the ink circulation system 200 provided in the printing device according to the embodiment of the disclosed technology. The ink circulation system 200 includes a main tank 202, a buffer tank 206, a main pump 208, a supply tank 214, a collection tank 222, a supply pump 228, a collection pump 234, pressure sensors 260 and 270, a controller 600, a reception unit 500, and pipes 204, 212, 216, 220, and 224. The ink circulation system 200 is a system that circulates the ink between the buffer tank 206 and the ink jet head 16. An ink circulation flow passage through which the ink circulates is composed of the pipes 204, 212, 216, 220, and 224, the supply tank 214, and the collection tank 222.

A color ink to be jetted by the ink jet head 16 is stored in the main tank 202. The ink may contain at least one of a metal pigment or carbon black. The viscosity of the ink is preferably in a range of 2 to 10 cm pores. 1 cm pore is 0.001 pascal seconds (Pa·s). It should be noted that, in the present specification, in a case in which a numerical range is indicated by using “to”, the numerical range includes numerical values of upper and lower limits indicated by “to”.

The main tank 202 is connected to the buffer tank 206 via the pipe 204. The main pump 208 is provided in the pipe 204. The main pump 208 is operated in response to a control signal Sc supplied from the controller 600, and feeds the ink stored in the main tank 202 to the buffer tank 206.

An inside of the buffer tank 206 is open to the atmosphere via an atmosphere opening hole 206A provided in a top surface thereof. A predetermined amount of the ink is stored inside the buffer tank 206 by the ink supplied from the main tank 202.

The buffer tank 206 communicates with the supply tank 214 via the pipe 212. The supply tank 214 communicates with the ink supply port 160 of the ink jet head 16 via the pipe 216.

In addition, the buffer tank 206 communicates with the collection tank 222 via the pipe 220. The collection tank 222 communicates with the ink collection port 162 of the ink jet head 16 via the pipe 224.

The supply pump 228 is provided in the pipe 212. The supply pump 228 feeds the ink from the buffer tank 206 to the supply tank 214. In addition, the collection pump 234 is provided in the pipe 220. The collection pump 234 feeds the ink from the collection tank 222 to the buffer tank 206.

An inside of the supply tank 214 is divided into an ink chamber 214A and a gas chamber 214B by an elastic film 238. The pipe 212 and the pipe 216 communicate with the ink chamber 214A. The ink stored in the buffer tank 206 is supplied by the supply pump 228 to the ink jet head 16 via the pipe 212, the ink chamber 214A, and the pipe 216.

On the other hand, the gas chamber 214B is filled with gas. An atmosphere opening pipe 242 for opening the gas chamber 214B to the atmosphere communicates with the gas chamber 214B. An atmosphere opening valve 244 is provided in the atmosphere opening pipe 242. The atmosphere opening valve 244 is operated in response to the control signal supplied from the controller 600 to open and close the atmosphere opening pipe 242. With the supply tank 214, sudden pressure change inside the supply flow passage including the pipe 212 and the pipe 216 is suppressed by the appropriate elastic force due to the compressibility of the air enclosed in the elastic film 238 and the gas chamber 214B.

The pressure sensor 260 detects a pressure inside the ink chamber 214A of the supply tank 214, and outputs a detection signal Sd indicating the magnitude of the detected pressure. The output detection signal Sd is supplied to the controller 600.

In the supply pump 228, a rotation speed per unit time (hereinafter, simply referred to as “rotation speed”) is controlled by the control signal Sc supplied from the controller 600.

The same also applies to the configuration of the collection tank 222. That is, an inside of the collection tank 222 is divided into an ink chamber 222A and a gas chamber 222B by an elastic film 246.

The pipe 220 and the pipe 224 communicate with the ink chamber 222A. The ink inside the ink jet head 16 is collected by the collection pump 234 into the buffer tank 206 via the pipe 224, the ink chamber 222A, and the pipe 220.

The gas chamber 222B is filled with gas. An atmosphere opening pipe 250 for opening the gas chamber 222B to the atmosphere communicates with the gas chamber 222B. An atmosphere opening valve 252 is provided in the atmosphere opening pipe 250. The atmosphere opening valve 252 opens and closes the atmosphere opening pipe 250 in response to the control signal supplied from the controller 600. With the collection tank 222, sudden change fluctuation inside the collection flow passage including the pipe 220 and the pipe 224 is suppressed by the appropriate elastic force due to the compressibility of the air enclosed in the elastic film 246 and the gas chamber 222B.

The pressure sensor 270 detects a pressure inside the ink chamber 222A of the collection tank 222, and outputs a detection signal Sd indicating the magnitude of the detected pressure. The output detection signal Sd is supplied to the controller 600.

A rotation speed of the collection pump 234 is controlled by the control signal Sc supplied from the controller 600.

A valve 265 is provided in the pipe 216, and a valve 275 is provided in the pipe 224. Each of the valves 265 and 275 opens and closes in response to the control signal Sc supplied from the controller 600. In the ink circulation system 200, in a case in which the ink circulates, the valves 265 and 275 are controlled to be in an open state. On the other hand, in the ink circulation system 200, in a case in which the ink circulation is stopped, the valves 265 and 275 are controlled to be in a closed state.

By driving the supply pump 228 and the collection pump 234, a circulation flow is generated in which the ink returns to the buffer tank 206 via the buffer tank 206, the pipes 212 and 216, the ink jet head 16, the pipe 224, and the pipe 220.

The reception unit 500 comprises operation members, such as operation buttons, a keyboard, and a touch panel, receives information input from the operation members, and outputs the received information to the controller 600. In a case in which the printing device is stopped, the ink circulation in the ink circulation system 200 is stopped. The reception unit 500 receives, for example, a set input value Ain of an ink circulation stop period, which is a period in which the ink circulation is stopped in the ink circulation system 200. The ink circulation stop period is a period in which the ink circulation in the ink circulation system 200 is stopped in a stop period of the printing device, and is, for example, a period optionally set based on an operation schedule of the printing device. An input operation of the set input value Ain of the ink circulation stop period is performed in a case in which the printing device is stopped by a user.

The controller 600 controls the circulation flow of the ink by controlling the supply pump 228, the collection pump 234, and the valves 265 and 275. In addition, in a case in which the printing device is stopped, the controller 600 controls a back pressure of the ink jet head 16 at the start of the ink circulation stop period based on the set input value Ain of the ink circulation stop period supplied from the reception unit 500 and a back pressure setting table 672 (see FIG. 17) to be described below. More specifically, by referring to the back pressure setting table 672, the controller 600 controls the back pressure of the ink jet head 16 at the start of the ink circulation stop period to a value in accordance with the set input value Ain of the ink circulation stop period. By controlling the rotation speeds of the supply pump 228 and the collection pump 234 per unit time, the controller 600 controls the back pressure of the ink jet head 16. The controller 600 specifies the back pressure of the ink jet head 16 from a difference between the pressure indicated by the detection signal Sd supplied from the pressure sensor 260 and the pressure indicated by the detection signal Sd supplied from the pressure sensor 270.

In a case in which the back pressure of the ink jet head 16 specified based on the detection signal Sd supplied from the pressure sensors 260 and 270 is the value in accordance with the set input value Ain of the ink circulation stop period, the controller 600 controls the valves 265 and 275 to be the closed state, and then stops the supply pump 228 and the collection pump 234. By stopping the supply pump 228 and the collection pump 234, the ink circulation is stopped. After stopping the ink circulation, a power supply of the printing device is turned off.

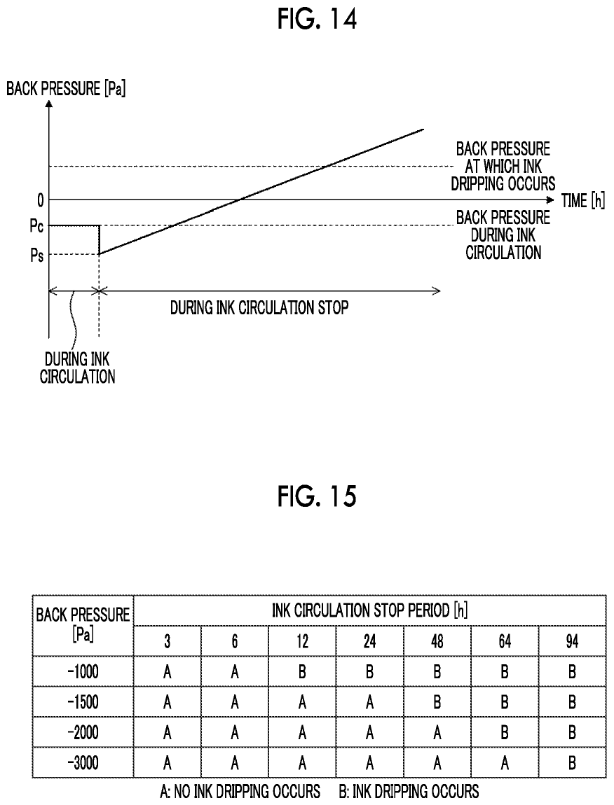

Here, FIG. 14 is a graph showing an example of a time transition of the back pressure of the ink jet head 16 according to a comparative example. It should be noted that, in the graph of FIG. 14, the back pressure indicated on a vertical axis is a relative pressure with an atmospheric pressure as 0 [Pa].

In an ink circulation period in which the printing device is operated, the back pressure of the ink jet head 16 is set to a set value Pc. By setting the set value Pc to a negative pressure, the meniscus formed in the outlet 131 of the ink jet head 16 can be maintained to have a shape recessed inward the ink jet head 16, so-called ink dripping in which ink leaks from the outlet 128 can be suppressed.

In a case in which the ink circulation in the ink circulation system 200 is stopped due to the stop of the printing device, the back pressure of the ink jet head 16 is set to a set value Ps which is a level further shifting to a negative side with respect to the set value Pc in the ink circulation period. Thereafter, the valves 265 and 275 are in the closed state, and the supply pump 228 and the collection pump 234 are stopped. Thereafter, the power supply of the printing device is turned off.

As shown in FIG. 14, the back pressure of the ink jet head 16 during the ink circulation stop period shifts to a positive pressure side with the elapse of time. Ink dripping occurs from the time when the ink circulation stop period is long, the back pressure exceeds the atmospheric pressure of 0 Pa, and a relationship of ink gravity>surface tension is satisfied. As described above, the back pressure of the ink jet head 16 during the ink circulation stop period shifts to the positive pressure side with the elapse of time, so that a risk of the occurrence of ink dripping is higher as the ink circulation stop period is longer.

In addition, in a case in which the printing device is stopped, the jetting surface 30 of the ink jet head 16 is covered with the cap 52 storing the moisturizing liquid in order to suppress the drying of the ink in the ink jet head 16. As a result, the humidity of the space formed between the jetting surface 30 and the cap 52 is maintained at about 90%, for example. However, in a case in which the jetting surface of the ink jet head 16 is exposed to a high humidity atmosphere, the ink in the vicinity of the outlet 128 absorbs moisture, or the ink in the vicinity of the outlet 128 binds to the water droplets adhering to the jetting surface 30 due to condensation, so that ink dripping is promoted.

<Experimental Results>

Here, FIG. 15 is a diagram showing a result of a timing at which ink dripping occurs in a case in which the set value of the back pressure of the ink jet head 16 at the start of the ink circulation stop period, which is acquired by an experiment. In the ink circulation stop period, the jetting surface 30 of the ink jet head 16 was covered with the cap 52 storing the moisturizing liquid. In FIG. 15, no ink dripping is indicated by A, and ink dripping is indicated by B.

In FIG. 15, the numerical values shown in the columns are the set values of the back pressure (unit: Pascal (Pa)) at the start of the ink circulation stop period, and the numerical values shown in the rows are the ink circulation stop periods (unit: h). The set value of the back pressure is the relative pressure with the atmospheric pressure as 0 [Pa].

The set values of the back pressure at the start of the ink circulation stop period were set to 4 patterns of −1000 Pa, −1500 Pa, −2000 Pa, and −3000 Pa, and periods from the start of the ink circulation stop period to the elapse of 94 hours were investigated. The inks used in the experiment were manufactured by FUJIFILM Corporation, the part numbers were black: C-WP-QK, cyan: C-WP-QC, magenta: C-WP-QM, and yellow: C-WP-QY, and the physical property values were viscosity: 5.4 mP·s and the surface tension: 36.6 mN/m.

As shown in FIG. 15, in a case in which the set value of the back pressure at the start of the ink circulation stop period was set to −1000 [Pa], no ink dripping occurred until 6 hours elapsed from the start of the ink circulation stop period. In a case in which the set value of the back pressure at the start of the ink circulation stop period was set to −1500 [Pa], no ink dripping occurred until 24 hours elapsed from the start of the ink circulation stop period. In a case in which the set value of the back pressure at the start of the ink circulation stop period was set to −2000 [Pa], no ink dripping occurred until 48 hours elapsed from the start of the ink circulation stop period. In a case in which the set value of the back pressure at the start of the ink circulation stop period was set to −3000 [Pa], no ink dripping occurred until 64 hours elapsed from the start of the ink circulation stop period.

As described above, as a negative pressure level (absolute value of the negative pressure) of the back pressure of the ink jet head 16 at the start of the ink circulation stop period is higher, the period in which no ink dripping occurs is longer in the ink circulation stop period. Therefore, by setting the set value of the back pressure of the ink jet head 16 at the start of the ink circulation stop period to the negative pressure having a larger absolute value as the ink circulation stop period is longer, it is considered that ink dripping can be suppressed in the ink circulation stop period.

In order to suppress ink dripping, in anticipation of the shift of the back pressure of the ink jet head 16 to the positive pressure side with time and the condensation on the jetting surface 30 of the ink jet head 16, it is also conceivable to set the set value of the back pressure of the ink jet head 16 to the negative pressure having a sufficiently large absolute value. However, in a case in which the negative pressure level of the back pressure of the ink jet head 16 is excessively increased, the meniscus of the ink formed in the vicinity of the outlet 128 becomes a shape that is more largely recessed inward the ink jet head 16, so that the ink in the vicinity of the outlet 128 tends to dry. In addition, air bubbles may enter the ink jet head 16, which may cause an ink jetting failure.

In the printing device according to the present embodiment, it has been found by the experiment that entering of air bubbles from the outlet 128 occurred in a case in which the back pressure was increased to exceed −5000 [Pa] on the negative side. That is, in a case in which the back pressure of the ink jet head 16 is set to the magnitude that does not exceed −5000 [Pa] on the negative side, it is possible to avoid entering of air bubbles. In addition, by setting the value of the back pressure of the ink jet head 16 to a range that does not excessively deviate from a limit value that does not cause ink dripping to the negative side, it is possible to suppress the shape, which is largely recessed inward the ink jet head 16, of the meniscus of the ink formed in the vicinity of the outlet 128, and it is possible to suppress drying of the ink in the vicinity of the outlet 128.

Therefore, by controlling the back pressure of the ink jet head 16 at the start of the ink circulation stop period as described below, the controller 600 suppresses ink dripping while suppressing drying of the ink and entering of air bubbles in the ink jet head 16. In the following, a hardware configuration of the controller 600 will be described.

<Hardware Configuration of Controller 600>

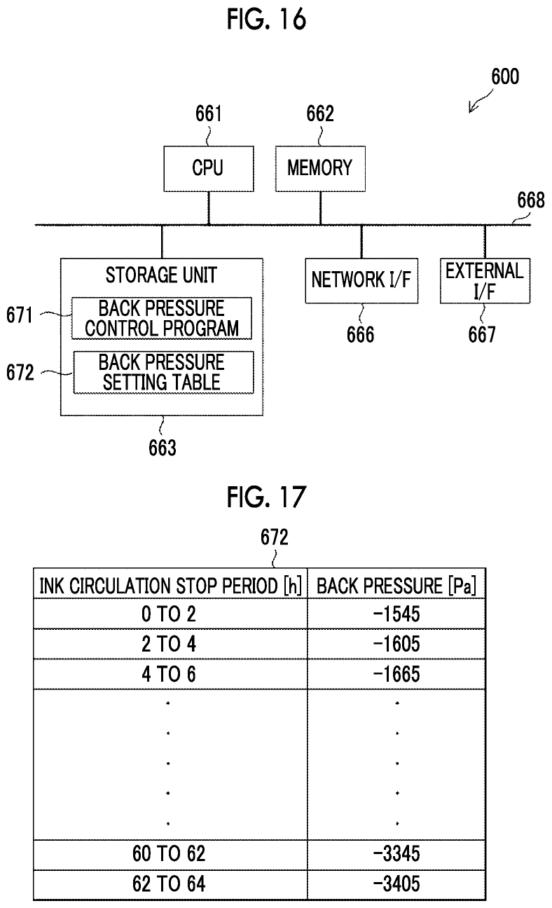

As shown in FIG. 16, the controller 600 includes a central processing unit (CPU) 661, a memory 662 as a transitory storage region, a non-volatile storage unit 663, a network interface (I/F) 666 connected to a network, and an external I/F 667.

The controller 600 is connected to the main pump 208, the supply pump 228, the collection pump 234, the pressure sensors 260 and 270, the valves 265 and 275, and the reception unit 500 via the external I/F 667.

The CPU 661, the memory 662, the storage unit 663, the network I/F 666, and the external I/F 667 are connected to a bus 668. The controller 600 may be a personal computer or a server computer, for example.

The storage unit 663 is realized by a hard disk drive (HDD), a solid state drive (SSD), a flash memory, and the like. A back pressure control program 671 and the back pressure setting table 672 are stored in the storage unit 663. The CPU 661 reads out the back pressure control program 671 from the storage unit 663, expands the read out back pressure control program 671 into the memory 662, and executes the expanded program.

In the following, the back pressure setting table 672 according to the first embodiment of the disclosed technology will be described.

<Back Pressure Setting Table>

FIG. 17 is a diagram showing an example of the back pressure setting table 672. As shown in FIG. 17, the back pressure setting table 672 records the ink circulation stop period and the set value of the back pressure of the ink jet head 16 at the start of the ink circulation stop period in association with each other. It should be noted that the set value of the back pressure shown in FIG. 17 is the relative pressure with the atmospheric pressure as 0 [Pa]. The back pressure setting table 672 is configured such that the set value of the back pressure is a value that does not cause ink dripping from the start of the ink circulation period to the elapse of the corresponding ink circulation stop period. In addition, the back pressure setting table 672 is configured such that the set value of the back pressure is larger on the negative side as the ink circulation stop period is longer. In addition, the back pressure setting table 672 is configured such that the set value of the back pressure does not exceed the limit value that does not cause entering of air bubbles. For example, in a case in which the limit value of the back pressure that does not cause entering of air bubbles is −5000 [Pa], the set value of the back pressure in the back pressure setting table 672 is set to a value that does not exceed −5000 [Pa] on the negative side. In addition, the back pressure setting table 672 is configured such that the set value of the back pressure is a value having a certain margin with respect to the limit value that does not cause ink dripping, but is in a range that does not excessively deviate from the limit value to the negative side. As a result, it is possible to suppress the shape, which is largely recessed inward the ink jet head 16, of the meniscus of the ink formed in the vicinity of the outlet 128, and it is possible to suppress drying of the ink in the vicinity of the outlet 128. That is, in the back pressure setting table 672, a value at which ink dripping in the corresponding ink circulation stop period can be suppressed while suppressing entering of air bubbles and drying of the ink is recorded as the set value of the back pressure. The back pressure setting table 672 can be created, for example, based on the experimental results shown in FIG. 15.

In the example shown in FIG. 17, the set value of the back pressure −1545 [Pa] is associated with the ink circulation stop period of less than 2 hours. This is because, in a case in which the ink circulation stop period is less than 2 hours, the back pressure of the ink jet head 16 at the start of the ink circulation stop period is set to −1545 [Pa], so that ink dripping in the corresponding ink circulation stop period can be suppressed while suppressing entering of air bubbles and drying of the ink. In addition, in the example shown in FIG. 17, the set value of the back pressure −1605 [Pa] is associated with a case in which the ink circulation stop period is 2 hours or more and less than 4 hours. This is because, in a case in which the ink circulation stop period is 2 hours or more and less than 4 hours, the back pressure of the ink jet head 16 at the start of the ink circulation stop period is set to −1605 [Pa], so that ink dripping in the corresponding ink circulation stop period can be suppressed while suppressing entering of air bubbles and drying of the ink.

The set value of the back pressure in the back pressure setting table 672 is not limited to that shown in FIG. 17, and need only be a value at which ink dripping in the corresponding ink circulation stop period can be suppressed while suppressing entering of air bubbles and drying of the ink. It is considered that the appropriate set value of the back pressure in the back pressure setting table 672 is changed in accordance with the configurations of the ink jet head 16 and the ink circulation system 200. In addition, in the example shown in FIG. 17, the case has been described in which the set value of the back pressure is defined in unit time of 2 hours, but the disclosed technology is not limited to this, for example, the set value of the back pressure may be defined the unit time of 4 hours or unit time of 6 hours, and does not have to be defined in a fixed unit time.

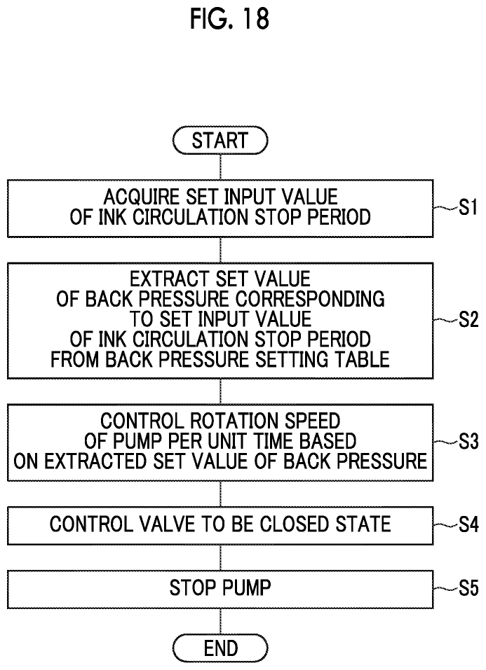

In the following, the actions of the printing device according to the first embodiment of the disclosed technology will be described. FIG. 18 is a flowchart showing a flow of a back pressure control process executed by the controller 600 executing the back pressure control program 671.

In a case in which the printing device is stopped, in a case in which the reception unit 500 receives the set input value of the ink circulation stop period, the CPU 661 of the controller 600 reads out the back pressure control program 671 from the storage unit 663 and executes the read out back pressure control program 671.

In step S1, the CPU 661 acquires the set input value of the ink circulation stop period received by the reception unit 500. The acquired set input value of the ink circulation stop period is recorded in the memory 662.

In step S2, the CPU 661 extracts, from the back pressure setting table 672 the set value of the back pressure corresponding to the set input value of the ink circulation stop period recorded in the memory 662. The extracted set value of the back pressure is recorded in the memory 662.

In step S3, the CPU 661 controls the rotation speeds of the supply pump 228 and the collection pump 234 per unit time in accordance with the set value of the extracted back pressure recorded in the memory 662. By controlling the rotation speeds of the supply pump 228 and the collection pump 234 per unit time, the back pressure of the ink jet head 16 is set to the value extracted from the back pressure setting table 672. Here, the back pressure of the ink jet head 16 can be adjusted by a difference between a flow rate of the ink flowing in the supply flow passage including the pipe 212 and the pipe 216 and a flow rate of the ink flowing in the collection flow passage including the pipe 220 and the pipe 224. Therefore, it is possible to control the back pressure of the ink jet head 16 by controlling the rotation speeds of the supply pump 228 and the collection pump 234 per unit time. The controller 600 specifies the back pressure of the ink jet head 16 from the difference between the pressure indicated by the detection signal Sd supplied from the pressure sensor 260 and the pressure indicated by the detection signal Sd supplied from the pressure sensor 270. The CPU 661 controls the rotation speeds of the supply pump 228 and the collection pump 234 per unit time such that the value of the back pressure of the ink jet head 16 specified based on the detection signal Sd supplied from the pressure sensors 260 and 270 matches the value extracted from the back pressure setting table 672. It should be noted that the CPU 661 may control the rotation speeds of the supply pump 228 and the collection pump 234 per unit time based on the table that records a correspondence relationship between the back pressure of the ink jet head 16 and the rotation speeds of the supply pump 228 and the collection pump 234 per unit time.

In step S4, in a case in which it is determined that the value of the back pressure of the ink jet head 16 specified based on the detection signal Sd supplied from the pressure sensors 260 and 270 reaches the value extracted from the back pressure setting table 672, the CPU 661 controls the valves 265 and 275 to be the closed state.

In step S5, the CPU 661 stops the supply pump 228 and the collection pump 234. By stopping the supply pump 228 and the collection pump 234, the ink circulation is stopped. After the ink circulation is stopped, the power supply of the printing device is turned off.

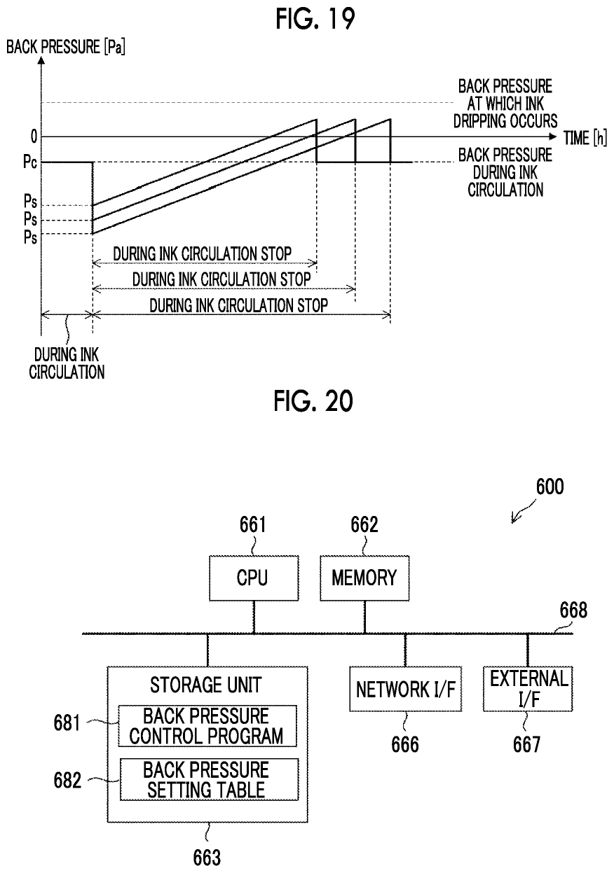

FIG. 19 is a graph showing an example of the time transition of the back pressure of the ink jet head 16 by a back pressure control according to the first embodiment of the disclosed technology. It should be noted that, in the graph of FIG. 19, the back pressure indicated on a vertical axis is a relative pressure with an atmospheric pressure as 0 [Pa].

With the printing device according to the first embodiment of the disclosed technology, as shown in FIG. 19, the back pressure of the ink jet head 16 at the start of the ink circulation stop period is set to the set value Ps (negative pressure) in accordance with the set input value of the ink circulation stop period received by the reception unit 500 by the controller 600 referring to the back pressure setting table 672. The controller 600 controls the negative pressure level of the back pressure of the ink jet head at the start of the ink circulation stop period to be higher as the ink circulation stop period is longer. Stated another way, the controller 600 controls the back pressure of the ink jet head at the start of the ink circulation stop period to the negative pressure having a larger absolute value as the ink circulation stop period is longer. As a result, even in a case in which the back pressure of the ink jet head 16 shifts to the positive pressure side with the elapse of time, the power supply of the printing device is turned on before the back pressure reaches the back pressure that causes ink dripping, and the ink circulation is restarted. By restarting the ink circulation, the back pressure of the ink jet head 16 is set to the set value Pc in the ink circulation period in which no ink dripping occurs. In addition, the set value Ps of the back pressure set based on the back pressure setting table 672 is set to a value that does not exceed the limit value that does not cause entering of air bubbles. As a result, it is possible to suppress entering of air bubbles in the ink jet head 16. In addition, the set value Ps of the back pressure set based on the back pressure setting table 672 is set to a value that does not excessively deviate from the limit value that does not cause ink dripping to the negative side. As a result, the shape, which is largely recessed inward the ink jet head 16, of the meniscus of the ink formed in the vicinity of the outlet 128 can be suppressed, and drying of the ink in the vicinity of the outlet 128 can be suppressed.

### Printing Device According to Second Embodiment

FIG. 20 is a diagram showing a hardware configuration of the controller 600 according to a second embodiment of the disclosed technology. In FIG. 20, the same elements as those of the controller (see FIG. 16) according to the first embodiment are designated by the same reference numerals, and the detailed description thereof will be omitted.

In the first embodiment, the storage unit 663 of the controller 600 comprises the back pressure control program 671 and the back pressure setting table 672, but in the second embodiment, the storage unit 663 of the controller 600 comprises a back pressure control program 681 and a back pressure setting expression 682.

The CPU 661 reads out the back pressure control program 681 from the storage unit 663, expands the read out back pressure control program 681 into the memory 662, and executes the expanded program.

In the following, the back pressure setting expression 682 according to the second embodiment of the disclosed technology will be described.

<Back Pressure Setting Expression>

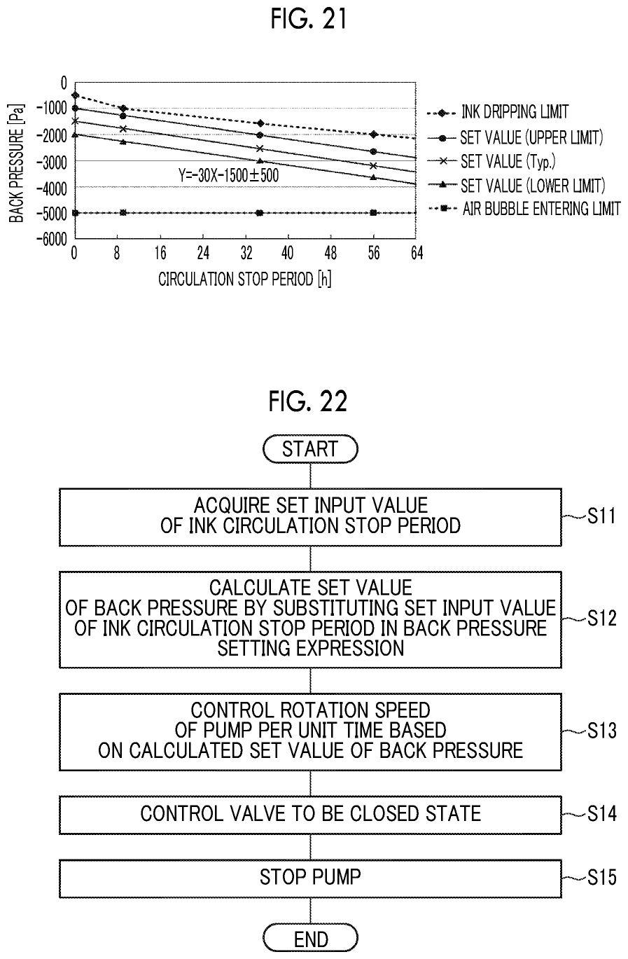

FIG. 21 is a graph showing an example of a relationship between the ink circulation stop period and the set value of the back pressure at the start of the ink circulation stop period in which no ink dripping occur. It should be noted that the graph shown in FIG. 21 corresponds to the experimental results shown in FIG. 15.

In FIG. 21, a standard value (cross plot), an upper limit value (circle plot), and a lower limit value (triangular plot) are shown for the set values of back pressure at the start of the ink circulation stop period in which no ink dripping occurs. It should be noted that, here, a value having a smaller absolute value of the back pressure is set as the upper limit value, and a value having a larger absolute value of the back pressure is set as the lower limit value. In addition, in FIG. 21, a limit value (diamond plot) that does not cause ink dripping and a limit value (square plot) that does not cause entering of air bubbles are shown. The back pressure is set within a range that does not exceed these limit values. Here, in a case in which the ink circulation stop period is defined as X [h] and the set value (relative pressure) of the back pressure at the start of the ink circulation stop period that does not cause ink dripping is defined as Y [Pa], the graph shown in FIG. 21 shows that a set value Y of the back pressure at the start of the ink circulation stop period is determined in accordance with an ink circulation stop period X to satisfy Expression (1). Expression (1) is stored in the storage unit 663 of the controller 600 as the back pressure setting expression 682. According to Expression (1), the set value Y of the back pressure of the ink jet head at the start of the ink circulation stop period is set to have negative pressure level, which is higher (to be the negative pressure having a larger absolute value) as the ink circulation stop period X is longer.

Y=−30X−1500±500 (1)

The back pressure setting expression 682 is not limited to Expression (1), and need only be an expression in which a value of the back pressure calculated by using the expression is a value that does not exceed the limit value that does not cause ink dripping in accordance with the ink circulation stop period, and does not exceed the limit value that does not cause entering of air bubbles in an assumed range of the ink circulation stop period.

The controller 600 controls the back pressure of the ink jet head 16 at the start of the ink circulation stop period by using the back pressure setting expression 682.

In the following, the actions of the printing device according to the second embodiment of the disclosed technology will be described. FIG. 22 is a flowchart showing a flow of the back pressure control process executed by the controller 600 executing the back pressure control program 681.

In a case in which the printing device is stopped, in a case in which the reception unit 500 receives the set input value of the ink circulation stop period, the CPU 661 of the controller 600 reads out the back pressure control program 681 from the storage unit 663 and executes the read out back pressure control program 681.

In step S11, the CPU 661 acquires the set input value of the ink circulation stop period received by the reception unit 500. The acquired set input value of the ink circulation stop period is recorded in the memory 662.

In step S12, the CPU 661 calculates the set value of the back pressure by substituting the set input value of the ink circulation stop period recorded in the memory 662 into the back pressure setting expression 682. The calculated set value of the back pressure is recorded in the memory 662.

In step S13, by controlling the rotation speeds of the supply pump 228 and the collection pump 234 per unit time in accordance with the calculated set value of the back pressure recorded in the memory 662, the CPU 661 sets the back pressure of the ink jet head 16 to the value calculated by using the back pressure setting expression 682. The controller 600 specifies the back pressure of the ink jet head 16 from the difference between the pressure indicated by the detection signal Sd supplied from the pressure sensor 260 and the pressure indicated by the detection signal Sd supplied from the pressure sensor 270. The CPU 661 controls the rotation speeds of the supply pump 228 and the collection pump 234 per unit time such that the value of the back pressure of the ink jet head 16 specified based on the detection signal Sd supplied from the pressure sensors 260 and 270 matches the value calculated from the back pressure setting expression 682. It should be noted that the CPU 661 may control the rotation speeds of the supply pump 228 and the collection pump 234 per unit time based on the table that records a correspondence relationship between the back pressure of the ink jet head 16 and the rotation speeds of the supply pump 228 and the collection pump 234 per unit time.

In step S14, in a case in which it is determined that the value of the back pressure of the ink jet head 16 specified based on the detection signal Sd supplied from the pressure sensors 260 and 270 reaches the value calculated from the back pressure setting expression 682, the CPU 661 controls the valves 265 and 275 to be the closed state.

In step S15, the CPU 661 stops the supply pump 228 and the collection pump 234. By stopping the supply pump 228 and the collection pump 234, the ink circulation is stopped. After the ink circulation is stopped, the power supply of the printing device is turned off.

With the printing device according to the second embodiment of the disclosed technology, as in the first embodiment, as shown in FIG. 19, the back pressure of the ink jet head 16 at the start of the ink circulation stop period is set to the set value Ps (negative pressure) in accordance with the set input value of the ink circulation stop period received by the reception unit 500 by the controller 600 using the back pressure setting expression 682. The controller 600 controls the negative pressure level of the back pressure of the ink jet head at the start of the ink circulation stop period to be higher as the ink circulation stop period is longer. As a result, even in a case in which the back pressure of the ink jet head 16 shifts to the positive pressure side with the elapse of time, the power supply of the printing device is turned on before the back pressure reaches the back pressure that causes ink dripping, and the ink circulation is restarted. By restarting the ink circulation, the back pressure of the ink jet head 16 is set to the set value Pc in the ink circulation period in which no ink dripping occurs. In addition, the set value Ps of the back pressure calculated by using a back pressure setting expression 682 is set to a value that does not exceed the limit value that does not cause entering of air bubbles. As a result, it is possible to suppress entering of air bubbles in the ink jet head 16. In addition, the set value Ps of the back pressure set based on the back pressure setting expression 682 is set to a value that does not excessively deviate from the limit value that does not cause ink dripping to the negative side. As a result, the shape, which is largely recessed inward the ink jet head 16, of the meniscus of the ink formed in the vicinity of the outlet 128 can be suppressed, and drying of the ink in the vicinity of the outlet 128 can be suppressed. In addition, by using the back pressure setting expression 682, the set value of the back pressure can be controlled more finely as compared to a case in which the back pressure setting table 672 is used.

<Others>

In the embodiment of the present invention, the printing device in a case in which the power supply of the printing device is turned on and the ink circulation is operated in accordance with the scheduled ink circulation stop period has been described. However, in a case in which the power supply of the printing device is not turned on and the ink circulation is not operated even after the scheduled ink circulation stop period has elapsed, a configuration can be adopted in which a program, which causes the controller 600 to measure the time from the ink circulation stop, turn the power supply of the printing device on, operate the ink circulation, set the value of the back pressure of the ink to the value during the ink circulation, and turn the power supply of the printing device off in a case in which the value reaches the set value, is added.

It should be noted that the disclosure of JP2019-223915 filed on Dec. 11, 2019 is incorporated in the present specification in its entirety by reference. In addition, all documents, patent applications, and technical standards described in the present specification are incorporated in the present specification by reference, to the same extent as in a case in which each of the documents, patent applications, and technical standards is specifically and individually described.

What is claimed is:

1. A printing device comprising:
an ink jet head that jets an ink from a jetting surface;
an ink circulation flow passage through which the ink circulates;
a moisturizing unit that moisturizes the jetting surface in an ink circulation stop period in which circulation of the ink in the ink circulation flow passage is stopped;
a reception unit that receives a set input value of the ink circulation stop period; and
a controller that controls a back pressure of the ink jet head at a start of the ink circulation stop period in accordance with the set input value of the ink circulation stop period received by the reception unit.

2. The printing device according to claim 1,
wherein the controller controls a negative pressure level of the back pressure of the ink jet head at the start of the ink circulation stop period to be higher as the ink circulation stop period is longer.

3. The printing device according to claim 1,
wherein the controller controls the back pressure of the ink jet head at the start of the ink circulation stop period by using a table in which the ink circulation stop period and a set value of the back pressure of the ink jet head are associated with each other.

4. The printing device according to claim 1,
wherein the controller controls the back pressure of the ink jet head at the start of the ink circulation stop period by using an expression representing a relationship between the ink circulation stop period and a set value of the back pressure of the ink jet head.

5. The printing device according to claim 4,
wherein, in a case in which the ink circulation stop period is defined as X [h] and the set value of the back pressure of the ink jet head at the start of the ink circulation stop period is defined as Y [Pa], the expression is Y=−30×X−1500±500.

6. The printing device according to claim 1,
wherein the controller controls a negative pressure level of the back pressure of the ink jet head not to exceed a preset limit value.

7. The printing device according to claim 1,
wherein the jetting surface of the ink jet head is inclined with respect to a horizontal direction.

8. The printing device according to claim 1,
wherein the ink jet head includes a plurality of head modules, and
the plurality of head modules are arranged such that adjacent head modules have a gap therebetween.

9. The printing device according to claim 1, further comprising:
a wiping section that wipes the jetting surface by a wiping member.

10. A back pressure control method of an ink jet head of a printing device including the ink jet head that jets an ink from a jetting surface, an ink circulation flow passage through which the ink circulates, and a moisturizing unit that moisturizes the jetting surface in an ink circulation stop period in which circulation of the ink in the ink circulation flow passage is stopped, the method comprising:
receiving a set input value of the ink circulation stop period; and
controlling a back pressure of the ink jet head at a start of the ink circulation stop period in accordance with the received set input value of the ink circulation stop period.
